(19) United States
(12) Patent Application Publication
(10) Pub. No.: US 2011/0177319 A1
(43) Pub. Date: Jul. 21, 2011

(54) HEAT AND PRESSURE GENERATED DESIGN

(75) Inventors: Göran ZIEGLER, Viken (SE); Kent Lindgren, Perstorp (SE)

(73) Assignee: Valinge Innovation Belgium BVBA, Kortrijk (BE)

(21) Appl. No.: 12/976,213

(22) Filed: Dec. 22, 2010

Related U.S. Application Data
(60) Provisional application No. 61/295,520, filed on Jan. 15, 2010.

(30) Foreign Application Priority Data
Jan. 15, 2010 (SE) 1050040-3

(51) Int. Cl. B32B 5/02; B05D 1/36

(52) U.S. Cl. 428/300.7; 427/201; 428/292.1

(57) ABSTRACT

A wood fibre based panel with surfaces layer with lower parts which has less binders than the upper parts. Also, a method of manufacturing a building panel having a structured surface with a design that has colour variation in register with the structure obtained by a varying pressure distribution applied on the surface.

### CROSS REFERENCE TO RELATED APPLICATIONS

The present application claims the benefit of U.S. Provisional Application No. 61/295,520, filed on Jan. 15, 2010, and claims the benefit of Swedish Application No. 1050040-3, filed on Jan. 15, 2010. The entire contents of each of U.S. Provisional Application No. 61/295,520 and Swedish Application No. 1050040-3 are hereby incorporated herein by reference.

### TECHNICAL FIELD

The disclosure generally relates to the field of fibre-based panels with wear resistant surfaces for building panels, preferably floor panels. The disclosure relates to building panels with such wear resistance surface and to production methods to produce such panels.

### BACKGROUND

Laminate flooring typically consists of layers of different materials that are compressed under heat to form a laminated board. The typical layers are an aluminum oxide containing melamine resin impregnated alfa cellulose paper, a melamine resin impregnated printed decorative paper, a wood fibre based carrier board (HDF) and a melamine resin impregnated balancing paper. Product designs are typically made by embossing the laminated product with a structured plate or paper during the press operation, and by printing the decorative paper with different designs and colors. At typical process conditions the depth of the structuration is typically less than 0.2 mm in order to yield proper looking products. Deeper structures tend to give crazing of the surface due to insufficient pressure in parts of the board area and the limitation of stretching of the paper layers. In order to give an even more natural looking product, the printed paper and the embossed structure can be coordinated giving products that are known in the field as embossed in register (EIR).

Wood Fibre Floor (WFF) is a new type of flooring product, disclosed in WO2009/065769, the entire contents of which are hereby incorporated by reference, that includes one or more layers of substantially homogenous powder mixtures that are heat compressed in processes akin to the processes used for making laminate floors. The homogenous powder mixtures typically include fibres such as wood fibres, polymer, such as melamine formaldehyde resin, hard particles, such as aluminum oxide particles and decorative materials, such as pigment particles, minerals and fibres. WFF products have a benefit over laminate floors as no papers with limited stretch capability are present, thus very deep structures can be made without yielding the observed crazing of the surface. While under heated compression the WFF powder mixture is almost liquid like in the sense that the composition flows under pressure to fill out the crevices in the structure.

### SUMMARY OF THE INVENTION

In WFF, just as in laminate flooring, it is of great interest to make natural looking products by having for example products that have color variations matching the structure variation. It has surprisingly been found that such products can be obtained in WFF by heat and pressure variations, giving the possibility to tailor the design in a controlled manner. Several methods to control the design are disclosed below.

By applying a pressure with an uneven distribution over the surface of a layer and given a fluidity of the layer, when the pressure is applied, which is sufficiently high, it is possible to cause parts of the composition in the layer to be displaced to the desired location. The fluidity can be increased by, for example, increasing the amount of the binder in the surface layer. The binder is preferably a melamine resin but other resins and binders may also be used.

This makes it possible to create and control the colour variation and match it with structure variations.

Control by formulation—By controlling the composition of the WFF powder mixture, such as the amount and/or type of polymer resin, such as melamine resin, the fluidity of the composition can be controlled to give more or less pressure difference (and thus more or less displacement) in the different parts of the surface during heat compression. Compositions giving a low pressure difference over the surface cause the substantially homogenous powder mixture to stay substantially homogenous giving a homogenous coloration over the surface. Compositions giving a higher pressure difference restrict the bulk powder fluidity and the homogeneity of the mixture will then be broken as the more fluid parts of the composition partially flow away. The result is a gradient of composition over the surface area. Thus, a color variation can be attained or avoided depending on the preference of the producer.

Other ways to change the fluidity of the composition is to alter the amount and/or type of fiber, use of processing aids such as plasticizers, solvents, reactive solvents and the like.

Control by heat—The typical WFF formulation consists partially of wood fibres. Such wood fibres are prone to darkening upon heating. By applying more or less heat over the surface the coloration can be controlled.

Control by pressure—Controlling the applied pressure in the heat-compressed state can also control the color difference. At higher pressure the bulk powder fluidity is restricted so the homogeneity of the powder mixture will be broken as described above to give a gradient in composition over the surface area.

Control by press plate design—By optimizing the surface area of the structure plate or paper, increased and/or decreased flow can be controlled, thus aiding in the control of color difference over the surface area.

Control by scattering, heterogeneous scattering—WFF powder can be scattered in a heterogeneous (nonuniform) way in order to provoke pressure difference over the surface area when the product is heat compressed. This can be sought after to make a local reinforcement such as in the parts of the board in which a locking element can be positioned. In such a case, the mechanical, chemical and water resistance can be optimized in the areas of the locking system that can be subjected to moisture, cleaning agents and mechanical wear.

Heterogeneous scattering can also be made to follow the structuration of the embossing plate or paper. In this case, the pressure difference can be matched to yield a product having an equal amount of material over the surface area giving equally good product properties and appearance over the surface.

Heterogeneous scattering can be used to enrich the amount of material in the protruding parts of the structure, so as to make increased chemical and mechanical properties in those parts of the surface that are subjected to the most stress from walking and cleaning.

Heterogeneous scattering can also be used to introduce differences in pressure over the area during heat compressing in excess of what is granted from the structuration of the press plate or paper. In this case, depending on the control of the bulk fluidity of the powder mixture, color variation can be controlled.

By employing more than one powder mixture the heterogeneous scattering can have a specific formulation tailored for the application. If a protruding part should be protected, this part can be richer in resins and wear particles compared to the bulk of the product, thus saving cost of the formulation. If water resistance of a locking system area should be optimized a more hydrophobic powder mixture can be used. If a specific decorative effect is sought, the powder fluidity can be optimized to give big color variation. Choice of pigment or other design material in the heterogeneous scattering can also be used.

Control by mechanical design—Removal or surface mixing of part of the scattered powder layer by means of blowing, sucking, brushing, scraping, cutting or equivalent are also means to introduce difference of pressure over the area during heat compression. In this case, similar effects of color variation due to pressure differences can be obtained as described above for heterogenous scattering. In the case of two or more powder layers being scattered on the surface, the effect of the partial removal or mixing can be further enhanced by, for example, differences in composition of the powder layers. A local mixing, micro mixing, of powders will cause a gradient in colorations that is further enhanced by the provoked pressure difference giving a further gradient in shading of the differently colored surface. The result is a possibility to make very complex color variations over the surface.

Partial removal or surface mixing as well as inhomogeneous scattering can easily be made using robots in order to either make the design actions in a controlled or uncontrolled way so as to give either identical or individual designs.

The control methods above can be used to tailor the properties of the product. As an example, an increased wear resistance might be desired on parts of the surface.

A first aspect of the invention is a building panel comprising a decorative surface layer 5 connected to a core 6. The surface layer is a mix comprising fibres 14, colour substance preferably colour pigments, a binder and wear resistant particles 12. Furthermore the surface layer comprises lower parts and upper parts and there is preferably a binder concentration gradient between the lower parts and upper parts. In a preferred embodiment the lower parts comprise less binder than the upper parts. The binder is in a preferred embodiment a resin.

A reversed condition could also be used. Having higher binder content in the lower part gives a gradient of flow to both the board and the upper part that can make it possible to have a saturated surface area between the board and the lower part.

The surface layer preferably has a substantially homogenous distribution of the wear resistant particles throughout the thickness of the layer and wear resistant particles are present from the bottom, and thereby in contact with the core, to the top.

The surface layer may in one embodiment comprise a sub layer and a top layer. The sub layer may not include wear resistant particles and colour pigments. In this case the sub layer can be considered as a scattered core.

Preferred embodiments of the first aspect of the invention are disclosed under Detailed Description of Embodiments and in the dependent product claims below.

A second aspect of the invention is a method of manufacturing a building panel having a structured surface with a design that comprises colour variation in register with the structure whereby the method comprises the steps of:
applying a layer comprising a mix of fibres, binder, preferably a resin, wear resistant particles, preferably aluminium oxide, and a colour substance, preferably colour pigments, on a carrier wherein the mix is floatable under heat and pressure
applying heat and pressure on the mix by a structured matrix comprising protrusions and cavities such that a controlled floating of the mix is obtained by the varying pressure distribution applied on the surface. In a preferred embodiment the resin content in the layer is adapted to the pressure such that a sufficient floating is obtained and preferably the binder is a resin and the weight content of the resin is at least 40% of the layer.

In order to increase the fluidity, the mass ratio between resins and fibres is preferably in the range of about 130-240%, more preferably in the range of 150-220%, most preferably in the range of about 180-200%. In the most preferred embodiment the mass ratio between resins and fibres is about 190%.

Preferred embodiments of the second aspect of the invention are disclosed under Detailed Description of Embodiments and in the dependent method claims below.

In order to increase the releasability, i.e., the ability to be released from and not stick to the press plate, a mass ratio between resins and the sum of the masses of the fibres and the coloring substances is preferably higher than about 60%, more preferably higher than about 100% and most preferably in the range of about 100-130%.

The layer in the method preferably has a substantially homogenous distribution of the wear resistant particles throughout the thickness of the layer and wear resistant particles are present from the bottom, and thereby in contact with the carrier, to the top.

Another aspect of the invention is to use the principles and control methods above to create a surface with even colour distribution and/or properties. In this case a layer with a fluidity, when the pressure is applied is used, that is sufficiently low, to maintain the substantially homogenous mix or substantially homogenous mix and distribution of the component in the layer. Such low fluidity can be obtained by having certain ratios between resins, fibres and pigments. One ratio could be calculated through dividing the mass of resins and the mass of fibres, this ratio is preferably less than about 90% and even more preferably less than about 80%. Another ratio could be between the mass of resins and the sum of the mass of fibres and the mass of coloring substances; this ratio is preferably higher than about 60% and in a preferred range of about 100-130%.

### BRIEF DESCRIPTION OF THE DRAWINGS

The following disclosure will be described in connection to preferred embodiments and in greater detail with reference to the appended exemplary drawings, wherein

FIG. 1 Illustrates a Wood Fibre Floor panel, and

FIG. 2 Illustrates a Wood Fibre Floor panel with registered embossing according to one embodiment of the invention.

### DETAILED DESCRIPTION OF EMBODIMENTS

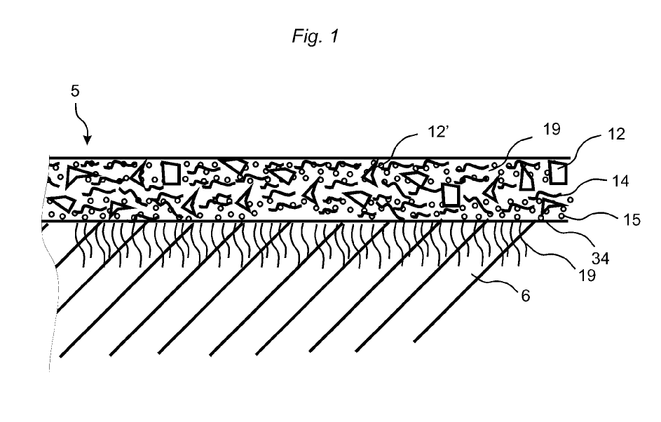

FIG. 1 shows a Wood Fibre Floor (WFF) panel of the type disclosed in WO 2009/065769, where the surface layer 5 has been formed on a core 6 that has been produced in a prior separate operation, for example a HDF panel. The surface layer comprises wood fibres 14, wear resistance particles 12 and a binder. The surface layer may in one embodiment comprise a sub layer and a top layer. This sub layer could be produced in the same way as the top layer and the same material compositions could be used except for the fact that in some embodiments wear resistant particles and colour pigments are not included. In this case the sub layer can be considered as a scattered core.

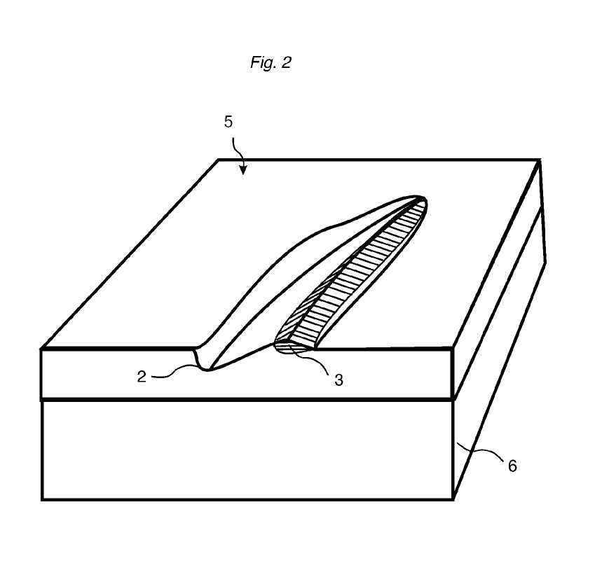

FIG. 2 shows one embodiment of a Wood Fibre Floor (WFF) panel according to the invention with colour variation 3 in register with the structure 2 of the surface layer 5.

Preferably the same scattering and pressing units as disclosed in WO 2009/065769 are used preferably together with a structured press plate in the method according to the invention. The panels according to the invention are preferably produced by this method.

In order to illustrate the effects of the parameters used in the control methods above, some examples are given below.

Examples 1-3 show the effect of changing the composition. Example 4 shows comparing with example 1 the effect of changing the pressure. The surface layer in Examples 1-4 is scattered in one layer. In Examples 5-6 the surface layer comprises a sub layer and a top layer. The surface layer is in all examples scattered on a HDF panel. Aluminium oxide is used as the wear resistant particles in all examples and the coloring substance is a pigment of Titanium Dioxide or combinations of Titanium Dioxide and Carbon Black.

### Example 1

### High Structure, Normal Pressure

Scattered amount: 600 g/m2
Carrier board: 8 mm HDF
Backing: 2 layers of NKR 140
Structure plate: 0.7 mm Slate Structure
Pressure: 45 kg/cm2,
Contact time: 25 sec
Press plate temperature: 160° C.

### One Surface Layer—Scattered Homogenously

| Component | Wt-% |
|---|---|
| Melamine Formaldehyde resin | 33 |
| Wood Fibre | 43 |
| Wear Resistant Particles: Aluminum Oxide | 13 |
| Coloring Substance: Titanium Dioxide | 11 |
| Sum | 100 |

The mass ratio between Melamine Formaldehyde Resin and dry components (Wood Fibre, Coloring Substance) is equal to 61%. The mass ratio between Melamine Formaldehyde Resin and Wood Fibre is equal to 77%. The resulting product is a homogenous off white product.

### Example 2

### High Structure, Normal Pressure

Scattered amount: 600 g/m2
Carrier board: 8 mm HDF
Backing: 2 layers of NKR 140
Structure plate: 0.7 mm Slate Structure
Pressure: 45 kg/cm2,
Contact time: 25 sec
Press plate temperature: 160° C.

### One Surface Layer—Scattered Homogenously

| Component | Wt-% |
|---|---|
| Melamine Formaldehyde resin | 47 |
| Wood Fibre | 25 |
| Wear Resistant Particles: Aluminum Oxide | 17 |
| Coloring Substance: Titanium Dioxide | 11 |
| Sum | 100 |

The mass ratio between Melamine Formaldehyde Resin and dry components (Wood Fibre, Coloring Substance) is equal to 131%. The mass ratio between Melamine Formaldehyde Resin and Wood Fibre is equal to 188%. The resulting product is a substantially homogenous off white product with some whiter spots at the ridges of the embossed structure.

### Example 3

### High Structure, Normal Pressure

Scattered amount: 600 g/m2
Carrier board: 8 mm HDF
Backing: 2 layers of NKR 140
Structure plate: 0.7 mm Slate Structure
Pressure: 45 kg/cm2,
Contact time: 25 sec
Press plate temperature: 160° C.

### One Surface Layer—Scattered Homogenously

| Component | Wt-% |
|---|---|
| Melamine Formaldehyde resin | 65 |
| Wood Fibre | 17 |
| Wear Resistant Particles: Aluminum Oxide | 11 |
| Coloring Substance: Titanium Dioxide | 7 |
| Sum | 100 |

The mass ratio between Melamine Formaldehyde Resin and dry components (Wood Fibre, Coloring Substance) is equal to 271%. The mass ratio between Melamine Formaldehyde Resin and Wood Fibre is equal to 382%. The resulting product is a substantially homogenous off white product with many whiter spots at the ridges of the embossed structure.

### Example 4

### High Structure, High Pressure

Scattered amount: 600 g/m2
Carrier board: 8 mm HDF
Backing: 2 layers of NKR 140
Structure plate: 0.7 mm Slate Structure
Pressure: 60 kg/cm2,
Contact time: 25 sec
Press plate temperature: 160° C.

### One Surface Layer—Scattered Homogenously.

| Component | Wt-% |
|---|---|
| Melamine Formaldehyde resin | 47 |
| Wood Fibre | 25 |
| Wear Resistant Particles: Aluminum Oxide | 17 |
| Coloring Substance: Titanium Dioxide | 11 |
| Sum | 100 |

The resulting product is a substantially homogenous off white product with many whiter spots at the ridges of the embossed structure. The mass ratio between Melamine Formaldehyde Resin and dry components (Wood Fibre, Coloring Substance) is equal to 131%. The mass ratio between Melamine Formaldehyde Resin and Wood Fibre is equal to 188%.

### Example 5

### Heterogeneous Scattering

Scattered amount: 300+300 g/m2
Carrier board: 8 mm HDF
Backing: 2 layers of NKR 140
Structure plate: 0.7 mm Slate Structure
Pressure: 45 kg/cm2,
Contact time: 25 sec
Press plate temperature: 160° C.

### Sub Layer Formulation—Scattered Homogenously.

| Component | Wt-% |
|---|---|
| Melamine Formaldehyde resin | 42.2 |
| Wood Fibre | 28.2 |
| Wear Resistant Particles: Aluminum Oxide | 25.8 |
| Coloring Substance: Titanium Dioxide | 3.5 |
| Coloring Substance: Carbon Black | 0.3 |
| Sum | 100 |

The mass ratio between Melamine Formaldehyde Resin and dry components (Wood Fibre, Coloring Substance) is equal to 132%. The mass ratio between Melamine Formaldehyde Resin and Wood Fibre is equal to 150%.

### Top Layer Formulation—Scattered Through a Shablon.

| Component | Wt-% |
|---|---|
| Melamine Formaldehyde resin | 49.5 |
| Wood Fibre | 40 |
| Wear Resistant Particles: Aluminum Oxide | 10 |
| Coloring Substance: Carbon Black | 0.5 |
| Sum | 100 |

The mass ratio between Melamine Formaldehyde Resin and dry components (Wood Fibre, Coloring Substance) is equal to 122%. The mass ratio between Melamine Formaldehyde Resin and Wood Fibre is equal to 124%. The resulting product is a dark grey product with a black pattern. In the more deeply embossed regions the black color is more intense compared to the more shallow regions.

### Example 6

### Mechanical Design

Scattered amount: 300 g/m2 Sub layer+300 g/m2 Top Layer
Carrier board: 8 mm HDF
Backing: 2 layers of NKR 140
Structure plate: 0.7 mm Slate Structure
Pressure: 60 kg/cm2,
Contact time: 25 sec
Press plate temperature: 160° C.

### Sub Layer Formulation—Scattered Homogenously.

| Component | Wt-% |
|---|---|
| Melamine Formaldehyde resin | 47.5 |
| Wood Fibre | 24.5 |
| Wear Resistant Particles: Aluminium Oxide | 17.5 |
| Coloring Substance: Titanium Dioxide | 10.5 |
| Sum | 100 |

The mass ratio between Melamine Formaldehyde Resin and dry components (Wood Fibre, Coloring Substance) is equal to 136%. The mass ratio between Melamine Formaldehyde Resin and Wood Fibre is equal to 194%.

### Top Layer Formulation—Scattered Homogenously.

| Component | Wt-% |
|---|---|
| Melamine Formaldehyde resin | 49.5 |
| Wood Fibre | 40 |
| Wear Resistant Particles: Aluminium Oxide | 10 |
| Coloring Substance: Carbon Black | 0.5 |
| Sum | 100 |

The mass ratio between Melamine Formaldehyde Resin and dry components (Wood Fibre, Coloring Substance) is equal to 122%. The mass ratio between Melamine Formaldehyde Resin and Wood Fibre is equal to 124%.

After scattering of the sub layer and the top layer, a robot scratched the surface in a programmed way to remove part of the top layer.

The resulting product is a black surface having a grey-white decoration according to the action of the robot.

1. A method of manufacturing a building panel having a structured surface with a design that comprises colour variation in register with the structure whereby the method comprises the steps of:
applying a layer comprising a mix of fibres, binder, wear resistant particles, and a coloring substance on a carrier wherein the mix is floatable under heat and pressure; and
applying heat and pressure on the mix by a structured matrix comprising protrusions and cavities such that a controlled floating of the mix is obtained by the varying pressure distribution applied on the surface.

2. The method according to claim 1, wherein the binder content in the layer is adapted to the pressure such that a sufficient floating is obtained.

3. The method according to claim 1, wherein the binder is a resin.

4. The method according to claim 1, wherein the binder is a resin and the weight content of the resin is at least 40% of the layer.

5. The method according to claim 1, wherein the mass ratio between resins and fibres is in the range of about 130-240%.

6. The method according to claim 1, wherein the mass ratio between resins and fibres is about 190%.

7. The method according to claim 1, wherein the mass ratio between binder and the sum of the masses of the fibres and the coloring substances is higher than about 60%.

8. The method according to claim 1, wherein the applied temperature is higher than about 150° C. and the applied pressure is more than about 30 bar.

9. The method according to claim 1, wherein the layer comprises a top-layer and a sub-layer having different colour pigments which are mixed by the floating.

10. The method according to claim 1, wherein the panel is a floor panel.

11. The method according to claim 1, wherein the carrier is a wood based core.

12. A building panel comprising a decorative surface layer connected to a core wherein the surface layer is a mix comprising fibres, coloring substance, a binder and wear resistant particles, and wherein the surface layer comprises lower parts and upper parts, wherein there is a binder concentration gradient between the lower parts and upper parts.

13. The building panel according to claim 12, wherein the lower parts comprises less binder than the upper parts.

14. The building panel according to claim 12, wherein the upper parts comprises less binder than the lower parts.

15. The building panel according to any claim 12, wherein the binder is a melamine resin.

16. The building panel according to claim 12, wherein the fibres are wood fibres.

17. The building panel according to claim 12, wherein the panel is floor panel

18. A method of manufacturing a building panel having plain coloured surface whereby the method comprises the steps of:
applying a layer comprising a mix of fibres, binder, wear resistant particles, and a coloring substance, on a carrier wherein the mix is floatable under heat and pressure; and
applying heat and pressure on the mix,
wherein the mass ratio between resins and fibres is less than about 90%.

19. The method of manufacturing a building panel according to claim 18, wherein the mass ratio between the binder and the sum of the masses of the fibres and the coloring substances is higher than about 60%.

20. A method of manufacturing a building panel having plain coloured surface whereby the method comprises the steps of:
applying a layer comprising a mix of fibres, binder, wear resistant particles, and a coloring substance, on a carrier wherein the mix is floatable under heat and pressure; and
applying heat and pressure on the mix,
wherein the mass ratio between the binder and the sum of the masses of the fibres and the coloring substances is higher than about 60%.

21. The method according to 20, wherein the binder is a resin.

23. A building panel produced according to the method of claim 20.
